(19) United States
(12) Patent Application Publication
(10) Pub. No.: US 2023/0240270 A1
(43) Pub. Date: Aug. 3, 2023

(54) SPECIES-SELECTIVE BIRD FEEDER

(71) Applicant: United States of America as Represented by the Secretary of Agriculture, Washington, DC (US)

(72) Inventor: Eric Anthony Tillman, Gainesville, FL (US)

(21) Appl. No.: 18/101,160

(22) Filed: Jan. 25, 2023

Related U.S. Application Data
(60) Provisional application No. 63/305,288, filed on Feb. 1, 2022.

(51) Int. Cl. A01K 39/01

(52) U.S. Cl. CPC A01K 39/01

(57) ABSTRACT

The species-selective bird feeder is a bird feeder with a feeding tray that is selectively coverable to only provide access thereto by particular bird species. The species-selective bird feeder includes a support, a feeding tray mounted on an upper end of the support, and a bird feed dispensing hopper supported on the feeding tray. An additional cage is provided for selectively covering the feeding tray. The cage includes at least one sidewall and an open lower end. The cage is vertically adjustable with respect to the support and the feeding tray, such that, in a raised position of the cage, the feeding tray is freely accessible to birds and, in a lowered position, the feeding tray is only accessible through the open lower end of the cage. In the lowered position, the open lower end of the cage is positioned beneath the feeding tray.

### CROSS-REFERENCE TO RELATED APPLICATIONS

This application claims the benefit of U.S. Provisional Patent Application No. 63/305,288, filed on Feb. 1, 2022.

### BACKGROUND OF THE INVENTION

### Field of the Invention

The disclosure of the present patent application relates to bird feeders, and particularly to a bird feeder which is only accessible to bird species with zygodactyl feet.

### Description of Related Art

Monk parakeets (Myiopsilta monachus) and rose-ringed parakeets (Psittacula krameri) are among the most invasive bird species in the world. When introduced into a new environment, both species have often had negative impacts on native species, habitats, economies and general human safety in the new environment. In order to control the invasive population, various types of chemical control agents have been used, including toxic compounds and contraceptives. Such chemical control agents are effectively delivered through food; however, it is very difficult to treat only the invasive species without non-target species accidentally eating the same food. Since attempting to design a bird food which would only be palatable to particular species of bird would be difficult, it would be desirable to make use of a bird feeder which would only allow the treated food to be accessible to the invasive species. Thus, a species-selective bird feeder solving the aforementioned problems is desired.

### SUMMARY OF THE INVENTION

The species-selective bird feeder is a bird feeder with a feeding tray that is selectively coverable to only provide access thereto by particular bird species, such as those with zygodactyl feet as a non-limiting example. The species-selective bird feeder includes a support, a feeding tray mounted on an upper end of the support, and a bird feed dispensing hopper supported on the feeding tray. An additional cage is provided for selectively covering the feeding tray. The cage includes at least one sidewall and an open lower end. The cage is vertically adjustable with respect to the support and the feeding tray, such that, in a raised position of the cage, the feeding tray is freely accessible to birds and, in a lowered position, the feeding tray is only accessible through the open lower end of the cage. In the lowered position, the open lower end of the cage is positioned beneath the feeding tray. Thus, in the lowered position, only birds with, by way of non-limiting example, zygodactyl feet (e.g., monk parakeets and rose-ringed parakeets, by way of non-limiting example), would be able to enter the cage through the open lower end to access the feeding tray, since the zygodactyl feet would allow these birds to grip the bottom end of the cage to maneuver inside.

In order to vertically adjust the cage to selectively cover and uncover the feeding tray, at least one cage supporting member is fixedly secured to the support. The cage is releasably attached to the at least one cage supporting member for vertically adjusting the cage with respect thereto. As a non-limiting example, the at least one cage supporting member may include a mounting rod and a mesh panel mounted on a free end thereof. The cage may then be releasably attached to the mesh panel.

The species-selective bird feeder may further include a feed-catching tray mounted on the support beneath the feeding tray for catching any bird feed which accidentally spills from the feeding tray. Additionally, a cover may be provided for releasably covering an open upper end of the bird feed dispensing hopper. Further, a plurality of prongs may be pivotally attached to the cage adjacent the open lower end thereof, thus providing additional barriers to non-target bird species.

These and other features of the present subject matter will become readily apparent upon further review of the following specification.

### BRIEF DESCRIPTION OF DRAWINGS

FIG. 1A is a perspective view of a species-selective bird feeder with a cage shown in a raised position.

FIG. 1B is a perspective view of the species-selective bird feeder of FIG. 1A, with the cage shown in a lowered position.

FIG. 2 is a partially-exploded side view of the species-selective bird feeder.

FIG. 3A is a perspective view of an alternative embodiment of the cage with prongs thereof shown in a deployed configuration.

FIG. 3B is a perspective view of the cage of FIG. 3A, with the prongs shown in a collapsed configuration.

Similar reference characters denote corresponding features consistently throughout the attached drawings.

### DETAILED DESCRIPTION

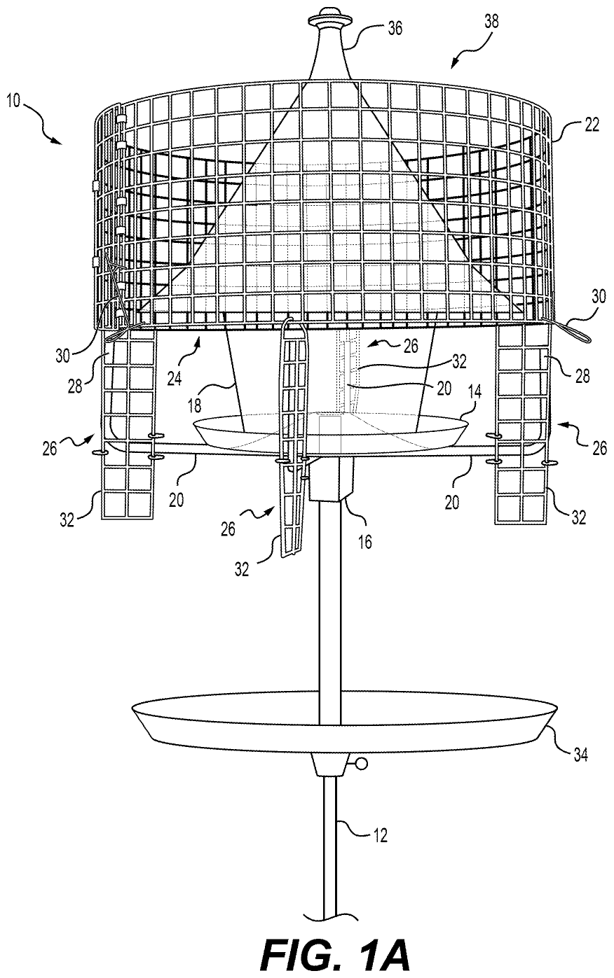

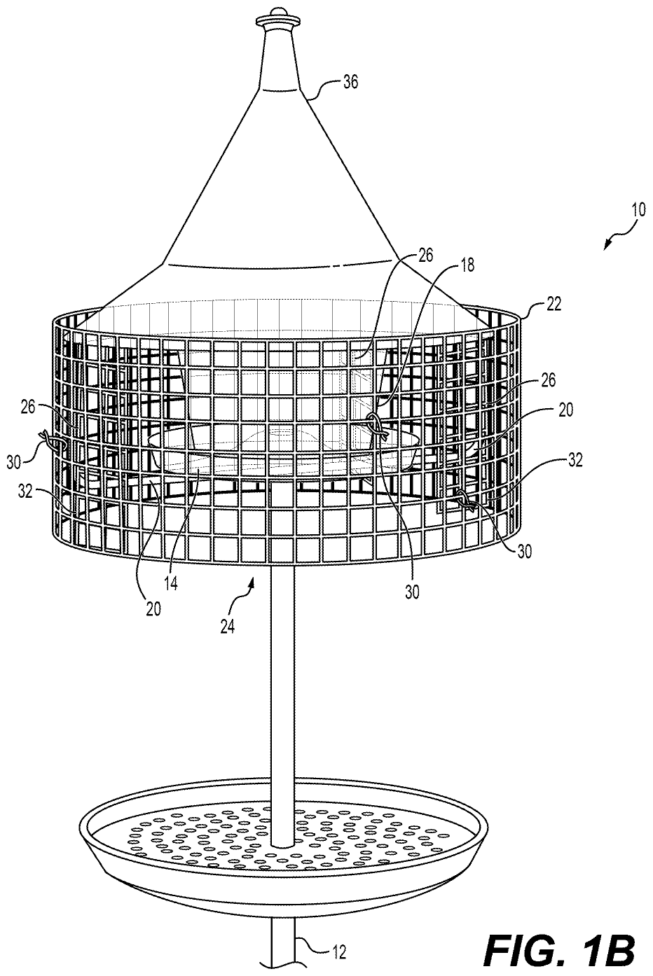

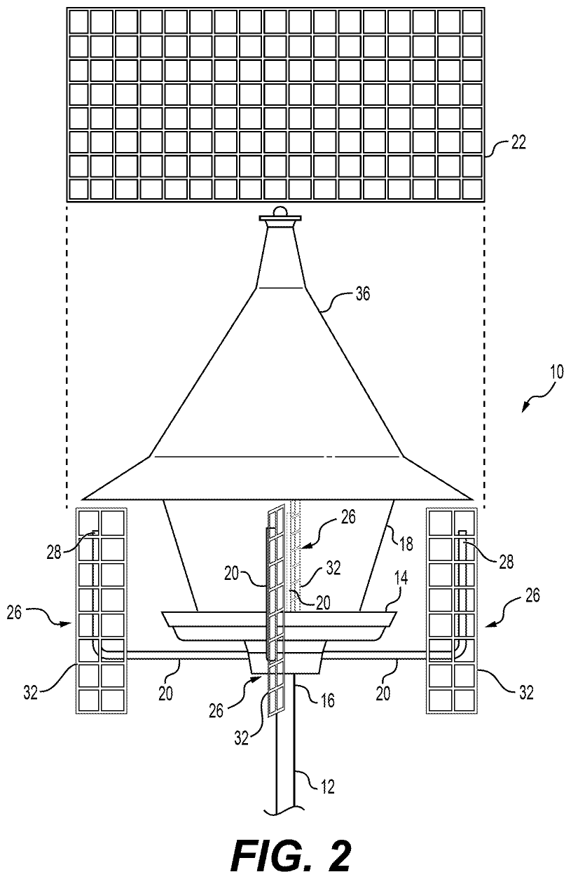

The species-selective bird feeder 10 is a bird feeder with a feeding tray 14 that is selectively coverable to only provide access thereto by particular bird species, such as those with zygodactyl feet as a non-limiting example. As shown in FIGS. 1A, 1B and 2, the species-selective bird feeder 10 includes a support 12, a feeding tray 14 mounted on an upper end 16 of the support 12, and a bird feed dispensing hopper 18 supported on the feeding tray 14. A cover 36 may be provided for releasably covering an open upper end of the bird feed dispensing hopper 18. As is conventionally known, the bird feed dispensing hopper 18 has openings or apertures to dispense bird feed into the feeding tray 14. It should be understood that any suitable type of dispensing arrangement may be provided for dispensing the bird feed from the hopper 18 to the feeding tray 14. One example of such a dispensing hopper/tray arrangement is shown in U.S. Pat. No. 5,791,286, issued to Taussig et al., which is hereby incorporated by reference in its entirety. In FIGS. 1A and 1B, feeding tray 14 and bird feed dispensing hopper 18 are shown formed from a transparent material, such as transparent plastic. However, it should be understood that the transparent feeding tray 14 and bird feed dispensing hopper 18 are shown for exemplary purposes only, and that feeding tray 14 and bird feed dispensing hopper 18 may be formed from any suitable material.

In the non-limiting example of FIGS. 1A, 1B and 2, the feeding tray 14 is shown as being substantially circular, the bird feed dispensing hopper 18 is shown as having a substantially frustoconical contour, and the cover 36 is shown as having a substantially conical contour. It should be understood that the shapes, sizes, relative dimensions and overall configurations of each of the support 12, feeding tray 14, bird feed dispensing hopper 18 and cover 36 are shown for exemplary purposes only.

A cage 22 is provided for selectively covering the feeding tray 14. The cage 22 includes at least one sidewall and an open lower end 24. In the non-limiting example of FIGS. 1A, 1B and 2, the cage 22 is shown as being cylindrical and sized to loosely seal around the lower end of the conical cover 36. However, it should be understood that the shape and relative dimensions of cage 22 are shown for exemplary purposes only, and that cage 22 may be manufactured in a variety of different sizes and shapes dependent upon the particular type of overall bird feeder which cage 22 is intended to cover. As best seen in FIGS. 1A and 1B, cage 22 may have an open upper end 38 to accommodate cover 36. However, as noted above, the overall configuration of cage 22 is shown for exemplary purposes only and may be varied.

The cage 22 is vertically adjustable with respect to the support 12 and the feeding tray 14, such that, in the raised position of FIG. 1A, the feeding tray 14 is freely accessible to all birds and, in the lowered position of FIG. 1B, the feeding tray 14 is only accessible through the open lower end 24 of cage 22. In the lowered position of FIG. 1B, the open lower end 24 of cage 22 is positioned beneath the feeding tray 14. Thus, in the lowered position, only birds with, for example, zygodactyl feet (e.g., monk parakeets and rose-ringed parakeets), would be able to enter the cage 22 through the open lower end 24 to access the feeding tray 14, since the zygodactyl feet would allow these birds to grip the bottom end of the cage 22 to maneuver inside.

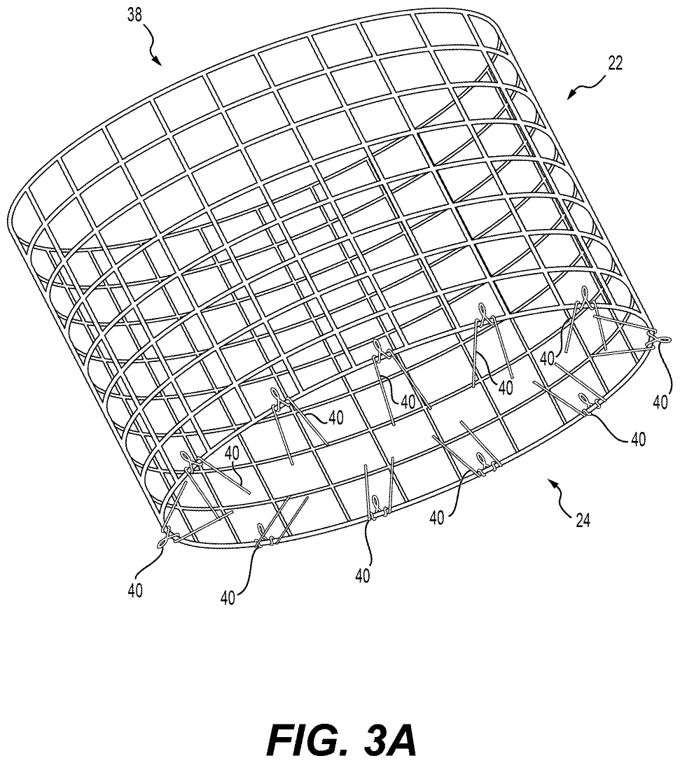

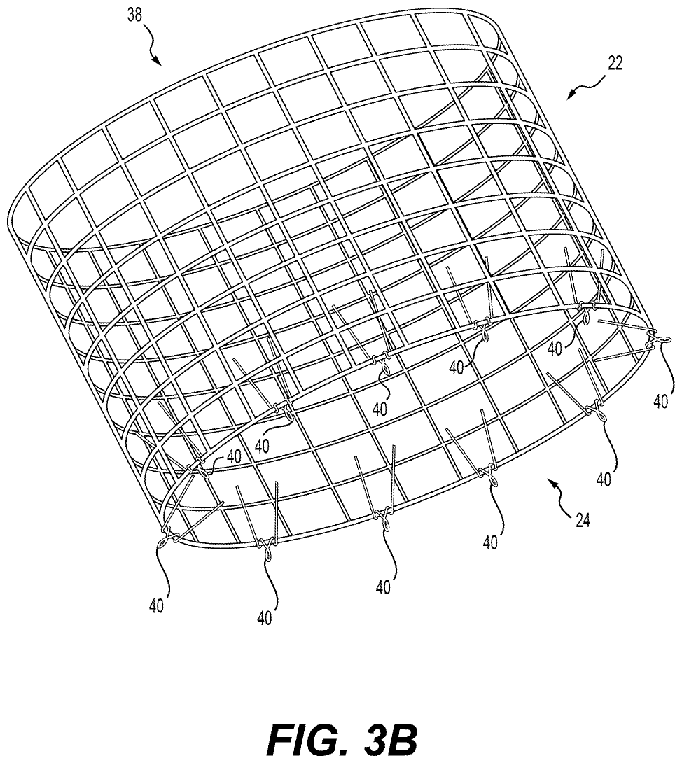

As shown in FIGS. 3A and 3B, an additional barrier may be provided to make it even more difficult for a non-target species of bird to access the feeding tray 14 when the cage 22 is in the lowered position. A plurality of prongs 40 may be pivotally attached to the cage 22 adjacent the open lower end 24. In FIG. 3A, the prongs 40 are deployed, requiring a bird to carefully maneuver between prongs 40 to enter the cage 22. As noted above, only birds with zygodactyl feet, for example, would have the dexterity to be able to maneuver between prongs 40. As shown in FIG. 3B, the prongs 40 may be selectively folded into a collapsed or stowed configuration for when cage 22 is in the raised position.

In order to vertically adjust the cage 22 to selectively cover and uncover the feeding tray 14, at least one cage supporting member 26 is fixedly secured to the support 12. In FIGS. 1A, 1B and 2, four such cage supporting members 26 are shown, however, it should be understood that the four cage supporting members 26 are shown for exemplary purposes only, and that any suitable number may be used. The cage 22 is releasably attached to the cage supporting members 26 for vertically adjusting the cage 22 with respect to the cage supporting members 26. As a non-limiting example, the at least one cage supporting member 26 may include a mounting rod 20 and a mesh panel 32 mounted on a free end 28 thereof. The cage 22 may then be releasably attached to the mesh panel 32. Mesh panels 32 provide an additional gripping surface for the zygodactyl feet of the target species, as discussed above.

It should be understood that cage 22 and mesh panels 32 may be made from any suitable material with any suitable mesh size. As a non-limiting example, cage 22 and mesh panels 32 may be made from welded wire mesh coated with polyvinyl chloride (PVC), with a mesh size of approximately 2.54 cm².

In FIGS. 1A and 1B, the cage 22 is shown releasably attached to mesh panels 32 by conventional cable ties 30, however, it should be understood that cable ties 30 are shown for exemplary purposes only and that mesh panels 32 may be releasably secured to cage 22 by any suitable type of releasable fixtures, such as clamps, ties, clips or the like. Further, in FIGS. 1A, 1B and 2, mounting rods 20 are shown as being substantially L-shaped (i.e., rods with bends which may be approximately 90°± any desired angular deviation, and with a bend which may be rounded, as shown). It should be understood that substantially L-shaped mounting rods 20 are shown for exemplary purposes only, and that mounting rods 20 may have any suitable contouring or relative dimensions. Further, it should be understood that the cage supporting members 26 are shown for exemplary purposes only and are not limited to the combination of mounting rods 20 and mesh panels 32. Cage supporting members 26 may have any construction suitable for the releasable attachment of cage 22 thereto.

The species-selective bird feeder 10 may further include a feed-catching tray 34 mounted on the support 12 beneath the feeding tray 14 for catching any bird feed which accidentally spills from the feeding tray 14. It should be understood that feed-catching tray 34 is shown in FIGS. 1A and 1B for exemplary purposes only and may have any suitable contouring and relative dimensions. It should be further understood that the species-selective bird feeder 10 may include any other type of accessories commonly associated with bird feeders and the like.

It is to be understood that the species-selective bird feeder is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A species-selective bird feeder, comprising:
a support;
a feeding tray mounted on an upper end of the support;
a bird feed dispensing hopper supported on the feeding tray; and
a cage for selectively covering the feeding tray, the cage having at least one sidewall and an open lower end,
wherein the cage is vertically adjustable with respect to the support and the feeding tray, such that, in a raised position of the cage, the feeding tray is freely accessible to birds and, in a lowered position of the cage, the feeding tray is only accessible through the open lower end of the cage, where the open lower end of the cage is positioned beneath the feeding tray in the lowered position of the cage.

2. The species-selective bird feeder as recited in claim 1, further comprising at least one cage supporting member fixedly secured to the support, wherein the cage is releasably attached to the at least one cage supporting member for vertically adjusting the cage with respect to the at least one cage supporting member.

3. The species-selective bird feeder as recited in claim 2, wherein the at least one cage supporting member comprises:
a mounting rod; and
a mesh panel mounted on a free end of the mounting rod.

4. The species-selective bird feeder as recited in claim 3, wherein the mounting rod is substantially L-shaped.

5. The species-selective bird feeder as recited in claim 1, further comprising a feed-catching tray mounted on the support beneath the feeding tray.

6. The species-selective bird feeder as recited in claim 1, further comprising a cover for releasably covering an open upper end of the bird feed dispensing hopper.

7. The species-selective bird feeder as recited in claim 1, wherein the cage has a cylindrical contour.

8. The species-selective bird feeder as recited in claim 7, wherein the cage has an open upper end.

9. The species-selective bird feeder as recited in claim 1, further comprising a plurality of prongs pivotally attached to the cage adjacent the open lower end thereof.

10. A species-selective bird feeder, comprising:
a support;
a feeding tray mounted on an upper end of the support;
a bird feed dispensing hopper supported on the feeding tray;
a cage for selectively covering the feeding tray, the cage having at least one sidewall and an open lower end; and
a plurality of prongs pivotally attached to the cage adjacent the open lower end thereof,
wherein the cage is vertically adjustable with respect to the support and the feeding tray, such that, in a raised position of the cage, the feeding tray is freely accessible to birds and, in a lowered position of the cage, the feeding tray is only accessible through the open lower end of the cage, where the open lower end of the cage is positioned beneath the feeding tray in the lowered position of the cage.

11. The species-selective bird feeder as recited in claim 10, further comprising at least one cage supporting member fixedly secured to the support, wherein the cage is releasably attached to the at least one cage supporting member for vertically adjusting the cage with respect to the at least one cage supporting member.

12. The species-selective bird feeder as recited in claim 10, wherein the at least one cage supporting member comprises:
a mounting rod; and
a mesh panel mounted on a free end of the mounting rod.

13. The species-selective bird feeder as recited in claim 12, wherein the mounting rod is substantially L-shaped.

14. The species-selective bird feeder as recited in claim 10, further comprising a feed-catching tray mounted on the support beneath the feeding tray.

15. The species-selective bird feeder as recited in claim 10, further comprising a cover for releasably covering an open upper end of the bird feed dispensing hopper.

16. The species-selective bird feeder as recited in claim 10, wherein the cage has a cylindrical contour.

17. The species-selective bird feeder as recited in claim 16, wherein the cage has an open upper end.
